(19) United States
(12) Patent Application Publication
(10) Pub. No.: US 2015/0319156 A1
(43) Pub. Date: Nov. 5, 2015

(54) INDEPENDENT IDENTITY MANAGEMENT SYSTEMS

(71) Applicant: INTERDIGITAL PATENT HOLDINGS INC., Wilmington, DE (US)

(72) Inventors: Louis J. GUCCIONE, East Chester, NY (US); Vinod K. CHOYI, Norristown, PA (US); Yogendra C. SHAH, Exton, PA (US); Andreas SCHMIDT, Frankfurt am Main (DE); Alec BRUSILOVSKY, Downingtown, PA (US); Yousif TARGALI, Cliffwood, NJ (US)

(21) Appl. No.: 14/651,455

(22) PCT Filed: Dec. 12, 2013
(86) PCT No.: PCT/US2013/074654

§ 371 Date: Jun. 11, 2015

Related U.S. Application Data
(60) Provisional application No. 61/736,407, filed on Dec. 12, 2012.
(60) Provisional application No. 61/765,354, filed on Feb. 15, 2013.

(51) Int. Cl. H04L 29/06

(52) U.S. Cl. CPC H04L 63/083; H04L 63/0853; H04L 63/0861

(57) ABSTRACT

Systems, methods and apparatus embodiments are described herein for authenticating a user and/or a user equipment (UE). For example, a user and/or UE may request access to a service controlled by a service provider (SP). The user may be authenticated by an identity provider (IdP), producing a result. A user assertion may be provided to the SP, and the user assertion may comprise the user authentication result. The UE may be authenticated with another IdP, producing an associated result. A device assertion may be provided to the SP and may comprise the device authentication result. A master IdP may bind the assertions together and a consolidated assertion may be provided to the SP so that the user/UE can receive access to a service that is provided by the SP.

### CROSS REFERENCE TO RELATED APPLICATIONS

This application claims the benefit of U.S. Provisional Patent Application Ser. No. 61/736,407 filed Dec. 12, 2012, and U.S. Provisional Patent Application Ser. No. 61/765,354 filed Feb. 15, 2013, the disclosures of both of which are hereby incorporated by reference as if set forth in their entireties herein.

### BACKGROUND

Many internet services (e.g., banking, multimedia, games, etc.) require authentication of a user of a mobile device before the service can be accessed. For example, enterprises and “over-the-top” application service providers can assert a user's identity to have the user authorized. Service providers often require users to create distinct registration profiles to access services that are provided by each service provider. Thus, users often have numerous passwords and user names to access various services, creating a significant burden on the user.

Two-factor authentication may be used in place of using a user password for authentication, or two-factor authentication may be used in addition to the use of user ID/password credentials. An exemplary two-factor authentication may be based on the user's ID/password as a first authentication factor and a hardware/software-based token as a second authentication factor. A user ID/password may authenticate a user's presence and a token may confirm the user's possession of the device on which the token functionality resides. Multi-factor authentication refers to any authentication that uses more than one factor. For example, a third factor, in addition to a user ID/password and a token, may be provided by a biometric (e.g., fingerprint, retina scan, etc.) of a user.

### SUMMARY

Systems, methods and apparatus embodiments are described herein for authenticating a user and/or a user equipment (UE). In one example embodiment, a master identity provider (M-IdP) receives a request from a service provider (SP) to authenticate a user who has who has requested access to a service via a user equipment (UE). The request may include an indication of an authentication requirement and an identity of the user that is associated with the M-IdP. The indication of the authentication requirement may include a required authentication assurance level. Alternatively, the indication of the authentication requirement may include an identification of required authentication factors. The M-IdP may determine a plurality of authentication factors that are capable of achieving the authentication requirement. Based on the user identity associated with the M-IdP, an identity of the user or the UE that is associated with select ones of the determined authentication factors may be determined. The identities that are associated with the select ones of the authentication factors are used to request an authentication for each select factor. The M-IdP may receive a result of the authentication for each select factor and may combine the results to create an authentication assertion that indicates successful authentication in accordance with the authentication requirement, for instance the required authentication assurance level. The authentication assertion may be sent to the service provider.

In another embodiment, master identity provider (M-IdP) receives a request from a service provider (SP) to authenticate a user who has requested access to a service via a user equipment (UE). The request may include an indication of an authentication requirement and an identity of the user that is associated with the M-IdP. The M-IdP determines a plurality of authentication factors capable of achieving the authentication requirement. The M-IdP may perform an authentication for select factors. The M-IdP may obtain a result of the authentication for the select factors and combine the results to create an authentication assertion that indicates successful authentication in accordance with the authentication requirement. The M-IdP may send the authentication assertion to the SP, directly or indirectly via the UE. In one embodiment, the M-IdP may select ones of the determined plurality of authentication factors that are capable of achieving the authentication requirement. The selection may be based on a user selection in accordance with one embodiment, or the selection may be based on pre-configured policies.

### BRIEF DESCRIPTION OF THE DRAWINGS

A more detailed understanding may be had from the following description, given by way of example in conjunction with the accompanying drawings wherein:

FIG. 1 is a flow diagram for multi-factor authentication using multiple identity providers (IdPs) according to an embodiment;

FIG. 2 is a table that illustrates an example of a mapping of authentication factors to authentication assurance levels;

FIG. 3 is a flow diagram for accessing a service using mobile subscriber credentials according an embodiment;

FIG. 4 is a flow diagram for accessing a service using mobile subscriber credentials and a third party identity provider (IdP) according to another embodiment;

FIG. 5 is a flow diagram for two-factor authentication that is controlled by a third party IdP according to an example embodiment;

FIG. 6 is a block system diagram that shows an example message exchange for secure two-factor authentication;

FIG. 7 is a flow diagram of a single sign-on (SSO) protocol that uses a third party IdP and an MNO authentication service according to an example embodiment;

FIG. 8 is a flow diagram of the SSO protocol illustrated in FIG. 6, with user credentials sent as part of Generic Bootstrapping Architecture (GBA) device authentication;

FIG. 9 is a flow diagram of another embodiment in which an IdP performs both a device and user authentication, and asserts the identities to a service provider (SP);

FIG. 10 is a flow diagram for multi-factor authentication in which GBA is implemented;

FIG. 11 is a flow diagram of an SSO protocol using two-factor authentication according to yet another example embodiment;

FIG. 12A is a system diagram of an example communications system in which one or more disclosed embodiments may be implemented;

FIG. 12B is a system diagram of an example wireless transmit/receive unit (WTRU) that may be used within the communications system illustrated in FIG. 12A; and

FIG. 12C is a system diagram of an example radio access network and an example core network that may be used within the communications system illustrated in FIG. 12A.

### DETAILED DESCRIPTION OF ILLUSTRATIVE EMBODIMENTS

The ensuing detailed description is provided to illustrate exemplary embodiments and is not intended to limit the scope, applicability, or configuration of the invention. Various changes may be made in the function and arrangement of elements and steps without departing from the spirit and scope of the invention.

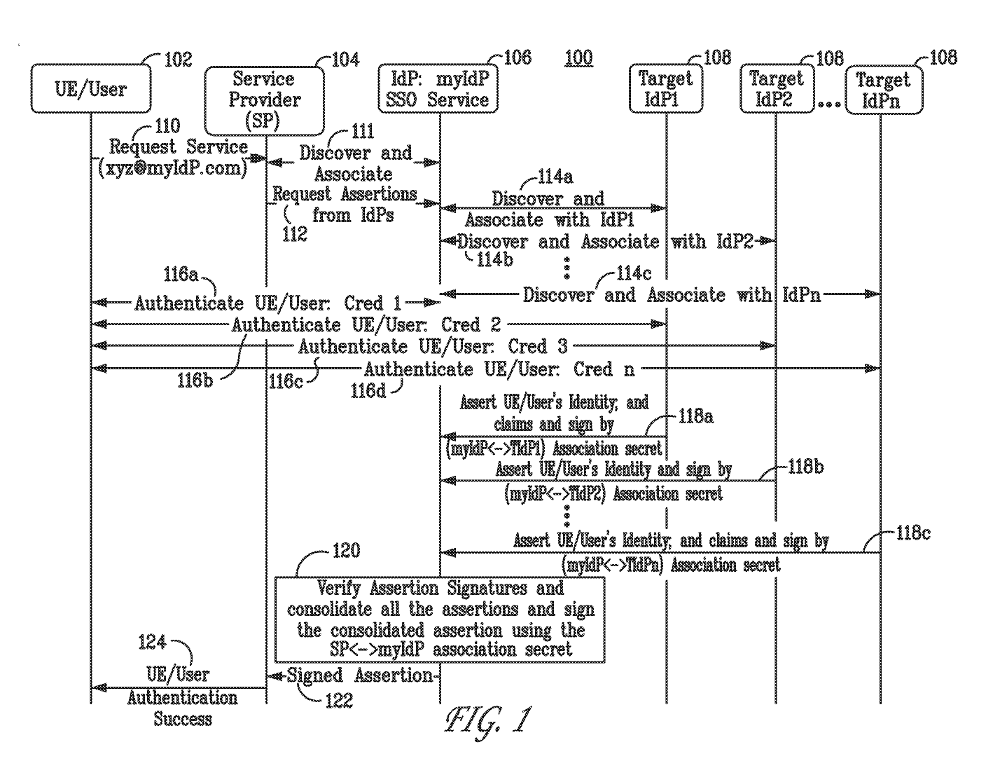

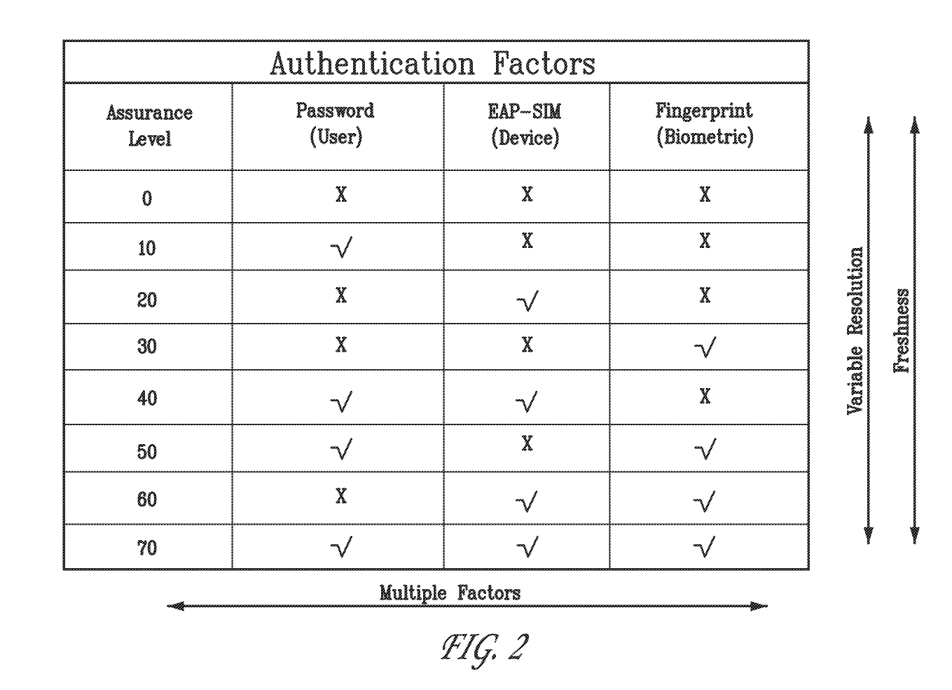

Referring generally to FIGS. 1-2, a master identity provider (M-IdP), which may also be referred to herein as a master IdP or myIdP, may receive a request from a service provider (SP) to authenticate a user who has requested access to a service via a user equipment (UE). The request may include an indication of an authentication requirement and an identity of the user that is associated with the M-IdP. The indication of the authentication requirement may include a required authentication assurance level. Alternatively, the indication of the authentication requirement may include an identification of required authentication factors, and thus the request may explicitly identify the required authentication factors. The M-IdP may determine a plurality of authentication factors that are capable of achieving the authentication requirement, for instance the required authentication assurance level. Based on the user identity associated with the M-IdP, an identity of the user or the UE associated that is associated with select ones of the determined authentication factors may be determined. The identities that are associated with the select ones of the authentication factors are used to request an authentication for each select factor. The M-IdP may receive a result of the authentication for each select factor and may combine the results to create an authentication assertion that indicates successful authentication in accordance with the required assurance level. The authentication assertion may be sent to the service provider. In one embodiment, each authentication result for each select factor is received from a different identity provider. In another embodiment, at least one up to all of the authentications for at least one up to all of the factors is performed at the M-IdP.

In another example embodiment in which a network includes a user equipment (UE), a service provider (SP) and a master identity provider (IdP), the master IdP may receive a request for a user assertion. The requested user assertion may indicate at least one result of at least one authentication of a user of the UE. The master IdP may delegate authentication to other identity providers, for example, based on policy requirements of the SP or based on requests by the user. The master IdP may provide the user assertion to the SP so that the user can receive access to service provided by the SP. The master IdP may communicate with at least one other IdP to create the user assertion. Identity providers (IdPs) with which the master IdP communicates may be pre-configured in the user's profile at the master IdP. Alternatively, an IdP that is trusted by the master IdP may be discovered (e.g., by a master IdP). The discovered IdP is able to provide an authentication assertion service. For example, an IdP may advertise its services which include an authentication assertion service. The IdP may advertise the capabilities of its authentication assertion service. For example, an IdP may advertise a particular strength (assurance level) of authentication it can provide and/or a freshness level of user authentication that it can provide. In an example embodiment, the master IdP is implemented by the mobile network operator (MNO) to which the user subscribes, and the MNO authenticates the user based on credentials associated with the user's subscription. In another example embodiment, multi-factor authentication of a user and/or a UE is performed, wherein a different IdP is responsible for each one of the multiple factors of authentication. In such an embodiment, a master IdP binds each of the assertions from each of the IdPs to provide an SP with a multi-factor authentication of a user and/or a UE. In yet another embodiment, the SP performs multi-factor authentication and/or acts as the master IdP.

In yet another example embodiment, a master IdP may perform a subset of authentications using a subset of authentication factors. For example, the master IdP may bind individual assertions obtained from other IdPs with each other and with authentication results from authentications performed by the master IdP. Thus, a combined assertion is created. The master IdP can forward the combined assertion to an SP. In an alternative embodiment in which multi-factor authentication is implemented, the master IdP receives individual assertions and forwards the individual assertions to the SP, and the SP determines and binds the multi-factor authentication result.

Tokens are often hardware-based and paired with an authentication server. Token functionality may reside outside of the dedicated token hardware platform. For example, token functionality may be provided via a specialized application or a smartphone application. Application (app) based token functionality may be less trustworthy than specialized hardware-based token functionality because, for example, token-specific code in application based implementations often do not run in a secure mode on tamper-resistant hardware.

As described herein, when a user equipment (UE) (e.g., smartphone) includes an universal integrated circuit card (UICC), the UE includes a tamper-resistant hardware element (UICC) that can be trusted to gain a high degree of authentication assurance. Thus, in various embodiments, the UICC may be mutually authenticated with its mobile network operator (MNO). Re-use of the user's UICC as a second authentication factor (e.g., proof of possession) allow MNOs to become identity (ID) providers (IdPs), and thus may provide more security than other forms or methods such as, for example, software-based token implementations. MNO-provided second factor authentication may be seamless to the user or to the over-the-top (OTT) application service. For example, the user may not have to manually enter information in the UE, such as a password for example. Additionally, delegating authentication services to a trustworthy identity provider, such as an MNO for example, using federated identity protocols provides a useful and scalable solution to secure user authentication.

In various example embodiments, multi-factor authentication may be facilitated by leveraging a mobile network operator's authentication infrastructure. In an example embodiment, multiple IdP subscriptions may be accommodated to support multi-factor authentication. For example, dynamic associations can be created between IdPs, and assertions may be sent between IdPs. The use of IdP identifiers is flexible. For example, an IdP identifier for an IdP may be applied to a different IdP, enabling the use of one identifier with other IdPs. This flexibility may be enabled through the application of pre-existing interworking agreements between an SP and one or more IdPs, for example. In addition, embodiments described herein can create authentication bindings cryptographically and can create authentication bindings based on protocols. Various implementations of multi-factor authentication are described herein, including authentication using MNO controlled frameworks with protocols such as GBA and EAP-SIM, and using OpenID authentication with various frameworks such as GBA and EAP.

The various approaches to single sign-on (SSO) described herein may alleviate authentications burdens on the user. In an example configuration, a user possesses a mobile subscription that provides services of voice, SMS, data, and the like. Such a mobile subscription may make provisions for SSO. For example, the mobile operator's SSO service may interwork with SSO services that are offered by one or more other independent entities, such as Facebook, Google, Yahoo, or the like. An entity that offers an SSO service may be referred to herein as an Identity Provider (IdP). For example, a mobile network operator (MNO) that offers an SSO service and an independent entity that offers an SSO service may both be referred to as an IdP. An independent IdP may also be referred to herein as a third party IdP. For example, from the perspective of an over-the-top (OTT) IdP (e.g., Facebook, Google, etc.), the MNO may be viewed as a third party IdP, and from the perspective of the MNO, the OTT IdP may be viewed as a third party IdP.

In an example configuration, a user is registered to the SSO service that is offered by the mobile operator and the SSO service that is offered by at least one independent entity. For example, users may wish to have the flexibility to use the identity/IdP identifier that is associated with the SSO service of their choice. A user may wish to use a particular IdP identifier regardless of the service (e.g., banking, multi-media, etc.) that the user accesses. After registering with multiple SSO services (e.g., mobile operator, an independent IdP, etc.) and subscribing to numerous services, a user might have personal profiles for each SSO service. The user may wish to access applications and/or non-SSO services by providing their preferred IdP identifier without providing other identifying information. Thus, a user is unburdened from having to memorize different (login) credentials for gaining access to various services that are offered by applications and/or non-SSO services. Applications and non-SSO services are generally referred to herein as service providers (SPs).

In order to access a service, a user may have to meet authentication requirements of an SP that provides the service. Authentication requirements may be based on authentication policies of the various services. For example, a policy of an SP may require that an authentication meets a predetermined assurance level (e.g., an authentication strength) before a service is accessed. By way of another example, an SP may require that specific authentication factors are used to perform multi-factor authentication. Thus, an indication of an authentication requirement may include a required authentication assurance level, or it may include an identification of required authentication factors. Referring to FIG. 2, assurance levels may indicate a strength of an authentication, and a high assurance level may require multiple factors of authentication. For example, an assurance level may refer to a level of assurance in which a user is authenticated, and the assurance level may be defined by an authority. The assurance level may be based on authentication protocols, the number of factors of authentication, the freshness of the authentication, and/or supplementary conditions. In an example embodiment, the desired assurance levels may be decided by different external authorities. For example, a service provider may determine the assurance level it requires to provide the requested service to the user. An external authority may specify assurance levels based on various criteria. Such criteria may include the security requirements for the application itself, the security policies of a company that hosts the services, or the like.

By way of another example, an SP may require that an authentication freshness level is met before allowing access to a service. For example, and without limitation, an SP may require that an authentication be carried out within the last 30 seconds. By way of another example, referring to FIG. 2, an SP may require an assurance level of at least ‘70’, and a combination of authentication factors, for example a user password, a device authentication, and a biometric authentication, may be capable of achieving the required authentication assurance level of 70. Multi-factor authentication may have to be accommodated in order to comply with authentication policies of a SP. Based on the various policies of SPs, for example, an SP may utilize multiple IdPs such that each IdP corresponds to a different authentication factor. For example, the security of each authentication protocol may be securely self-contained at the respective IdP, which may be referred to as an authentication endpoint (AEP), on the network. In accordance with another embodiment, an SP may utilize IdPs that accommodate more than one authentication factor. As described herein, the user's home MNO may offer IdP services, and the MNO may be involved in authentication. One or more third party IdP entities may also be involved in authentication.

Referring to FIG. 1, in a network 100 that includes a UE/user 102, a service provider (SP) 104, and a master IdP 106, the user makes an initial request, at 110, for access to a service that is provided by the SP 104. At 112, the request is redirected by the SP 104 to the master IdP 106. An IdP may be designated as a master IdP by determination of a user's preferred identifier, and thus the master IdP may also be referred to as myIdP herein, without limitation. In an example embodiment, the master IdP 106, through its interworking agreement with the SP 104, has responsibility for authenticating the user and/or the UE. For example, the master IdP 106 may comprise assets to perform the authentication itself, whether the authentication is one-factor or multi-factor. Alternatively, the master IdP 106 may employ the assets of other IdPs, such as IdPs 108 for example, in addition to or in lieu of its assets.

With continuing reference to FIG. 1, at 112, the master IdP 106 receives a request from the SP 104 to authenticate a user that has requested access to a service via the UE 102. The request may include an indication of a required assurance level and an identity of the user. The identity in the request may be associated with the master IdP (e.g., xyz@myIdP.com). For example, in the SP's redirection message to the master IdP 106 at 112, the SP 104 may communicate that strong device authentication is required.

In an example embodiment in which a strong authentication is required, for example when a high required assurance level is received by a master IdP, the master IdP may involve the MNO to which the user subscribes. The master IdP may direct the MNO to employ its generic bootstrapping architecture (GBA) capabilities to fulfill the requirement of an SP. In an alternative example configuration, an SP policy may require device authentication via GBA in order to provide an end user with a seamless login experience. Alternatively, an SP may require user proof of presence and device level authentication according to another example policy. For example, if two (e.g., device and user) authentication factors have been registered with the master IdP, the master IdP itself may accommodate the authentication requirements. In yet another configuration, the master IdP acts as an aggregation agent and redirects authentications to other IdPs. By way of another example, an MNO may handle multiple authentication factors or authentication factors may be distributed across more than one IdP.

In an example embodiment, an IdP has a local proxy function on the UE which helps to perform an authentication locally, for example, under delegation from a master IdP. When an IdP is described herein as capable of authenticating the user (or UE) with respect to a specific set of credentials, the user may have previously registered those credentials with that IdP service.

Referring generally to FIG. 1, the user has a subscription to an SSO Service (e.g., Facebook, Google, or the like) that provides an identifier (e.g., xyz@myIdP.com). Such an identifier may be used to gain access to multiple services to which the user subscribes. At 111, the SSO Service (master IdP 106) is discovered by the SP 104 and, upon request for example, the SSO service authenticates the user and asserts such authentication to the SP 106. The SP 106 evaluates the assertion and grants or denies service to the user. In an example embodiment, multiple IdPs 108 may interwork together, and one of the IdPs that is referred to herein as a master (e.g., the master IdP 106), may trigger the authentications and assertions. For example, SSO services such as Facebook, Google, Yahoo, or the like may provide IdP services and may perform the duties of the master IdP. With reference to FIG. 1, the master IdP 106 may be collapsed into the SP 104 in an example embodiment, and thus the SP can be the master IdP. Thus, the SP 104 can authenticate one or more factors and the SP 104 can delegate other IdPs 108 for additional factors. For example, such a scenario may be apply to a secure VPN setup use case.

As shown in FIG. 1, the user may have credentials that are associated with the IdPs 108 in addition to the master IdP 106. In an example scenario in which multi-factor authentication is required by the SP 104, authentication using multiple user/device credentials may be necessary. For example, the request at 112 may include an indication of an authentication requirement, such as a required assurance level. Based on the authentication requirement, the master IdP 106 determines a plurality of authentication factors that are capable of achieving the authentication requirement. For example, referring also to FIG. 2, depending on a required assurance level, various authentication factors or various combinations of authentication factors may achieve the assurance level required by the SP 104 to access a service. Based on the user identity (e.g., xyz@myIdP.com in FIG. 1) that is associated with the M-IdP 106, the M-IdP 106 determines an identity of the user or the UE 102 that is associated with select ones of the determined authentication factors. Thus, the identity that corresponds to the M-IdP may be associated with identities that correspond to other identity providers. Such other identity providers may each be responsible for an authentication using a particular authentication factor. In accordance with the illustrated embodiment, the M-IdP 106 determines identities associated with the IdPs 108. For example, with particular reference to FIG. 1, the IdP 108a may store user information such as a password. The IdP 108b may possess biometric information for example. The IdP 108c may be an MNO that possesses the user's mobile subscriber credentials such that the MNO offers IdP services. In an example configuration, another IdP may comprise basic user profile information for user proof of presence purposes.

Still referring to FIG. 1, the user sends his/her identifier (xyz@myIdP.com) to the SP 104 at 110. At 114a-c, the master IdP 106 delegates authentication to the IdPs 108a-c, respectively, and requests assertions from them. Thus, at 114a-c, using the identities associated with the select ones of the authentication factors, an authentication is selected for each select factor. It will be understood that the master IdP 106 may perform authentications using one or more authentication factors, thereby obtaining one or more authentication results. The master IdP 106 and the IdPs 108 may have static or dynamic interworking agreements that are facilitated by databases and/or corresponding mapping arrangements. Such agreements may ensure that the delegated authentication responsibilities function according to the security policies of the SP 104. Further, mapping arrangements may associate an identity that is associated with the master IdP 106 to the identities that are associated with the other IdPs 108. In accordance with the illustrated embodiment, at 116a, the master IdP 106 performs authentication of the UE/user 102 using its stored credentials. At 116b-d, the IdPs 108a-c, respectively, perform authentication of the user or UE using their respective stored credentials (e.g., biometric, username-password, or the like). The IdPs 108a-c may encrypt the results for each authentication factor, and the IdPs 108a-c may sign the results of each authentication factor. At 118a-c, the IdPs 108a-c, respectively, assert the result of their respective authentications to the master IdP 106. Thus, the master IdP 106 receives a result of the authentication for each select factor. At 120, the authentication results (assertions) are combined by the master IdP 106 to create an authentication assertion that indicates successful authentication in accordance with the authentication requirement, for instance the required assurance level. The combined or consolidated authentication assertion may be signed by the master IdP 106 using the association secret from 111. The combined authentication assertion may be encrypted. For example, the independent authentication assertions that come from the delegated IdPs 108a-c may be bound together. It will be understood that while three delegated IdPs 108a-c are illustrated in FIG. 1, any number, for instance less than three or greater than three, of IdPs may be used as desired. At 122, the master IdP 106 sends the signed authentication assertion to the SP 104. At 124, the SP 104 may send the UE 102 an indication that the user and the UE have been authenticated in accordance with the authentication requirement, for instance to the required authentication level, and thus the user and UE may receive access to the requested service.

Still referring to FIG. 1, in an example configuration, the user/UE 102 has registered its capabilities for multi-factor authentication with the SP 104 and/or the master IdP 106. In an alternative embodiment, such discovery information is included in the information elements sent by the user/UE 102 to the SP 104 and/or the IdP 106. In yet another embodiment, the capabilities are discovered and negotiated/agreed upon for subsequent authentication. The user/UE 102 may negotiate and/or reach agreements with the SP 104 and/or the IdP 106.

An interworking relationship may have been established between the master IdP and the other IdPs to facilitate discovery and authentication. In an alternative embodiment, the discovery information is included in the identifier, sent at 110 for example. Other information elements may be passed by the user/UE 102 in the initiation of the service from the SP 104. An example of such an aggregate identifier is a decorated identifier.

The user may have identifiers that are associated with each of the IdPs 108. In an example embodiment, each of the IdPs 108 may perform the functions of the master IdP 106. Although not shown in FIG. 1, a subset of IdPs may be requested to provide authentication assertions by the delegating IdPs 108a-c. Thus, at least one of the IdPs 108a-c may send a request to another IdP to perform an authentication, such that the other IdP performs the authentication on behalf of the at least one IdP 108a-c.

Some example variants to the IdP architecture that was described with reference to FIG. 1 are described herein. Various example configurations described herein employ a master IdP that is selected by the user (e.g., myIdP). For example, the user may supply the identifier of the master IdP (e.g., xyz@myIdP.com) to the SP with the request for service message. The user may have configuration discretion. For example, a user may determine which IdP is the master. This discretion is restricted in accordance with an example embodiment. For example, in accordance with an example embodiment, an IdP may be a master if the user is registered with the IdP and the IdP has an interworking relationship with the desired SP. If, for example, the user wants the mobile operator to which the user subscribes to be the master, the request for service message may include an MNO identifier, such as xyz@mymno.com for example. Before accepting the identifier, the SP checks to determine whether the IdP is affiliated and the interworking relationship is sufficient for authentication purposes. For example, the SP may verify that the IdP is trustworthy. Alternatively, the master IdP may be implied based on the identity that is selected by the user. For example, if the user selected his or her Google identity for accessing a service, then Google, via an implication, becomes the master IdP according to an example embodiment.

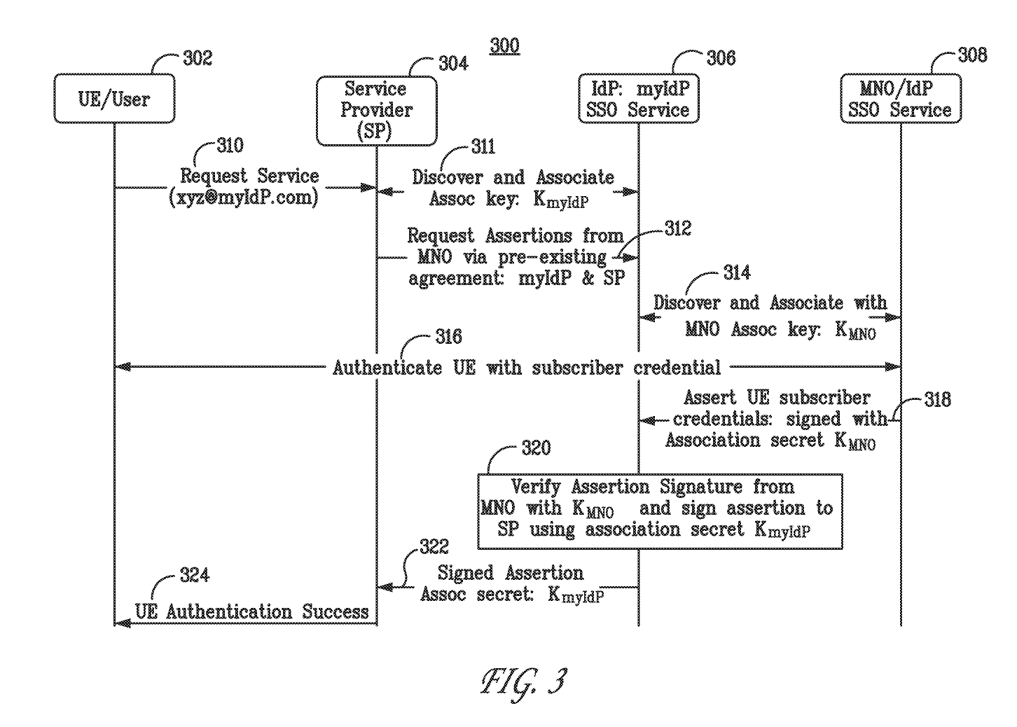

Referring to FIG. 3, a network 300 includes a UE 302, a SP 304, a master IdP 306, and an MNO 308. It will be understood that reference numbers that appear in more than one figure refer to the same or similar features in each figure. In accordance with the illustrated embodiment, the user/UE 302 subscribes to the MNO 308. The MNO 308, and in particular MNO subscriber credentials, is employed for authentication using one of the factors to provide the user with automatic access to services. At 310, the user wants to login to a service provided by the SP 304 using a pre-established and/or a common username. For example, the user may use an identity that is provided by an internet identity services provider. The identity may be a unique user account name. Examples of such account names include Facebook identities and Google email addresses. In accordance with the illustrated embodiment, the SP 304 requires that an authentication of the user/UE 302 is provided by a different authenticator than what the user provides at 310. For example, the SP 304 may want to use the MNO 308 that uses the authentication of an UICC to authenticate the user/UE 302.

Still referring to FIG. 3, one-factor device authentication is implemented. Such authentication may be implemented using the MNO infrastructure and GBA, for example as described in 3GPP TR 33.924: “Identity management and 3GPP security interworking; Identity management and Generic Authentication Architecture (GAA) interworking”. At 311, the SSO Service (master IdP 306) is discovered by the SP 304 and an association key (K_{myIdP}) is created. In accordance with the illustrated embodiment, based on an authentication policy of the SP 304, at 312 the SP 304 indicates to the master IdP 306 that strong device authentication (e.g., authentication having a high assurance level) performed by the MNO 308 is required. Such an indication of the authentication requirement may represent a directive to the master IdP 306 to request device authentication from the MNO 308. At 314, the master IdP 306 delegates authentication to the MNO 308 and requests assertions from the MNO 308. The MNO 306, in addition to being able to function as an IdP, may function as a network application function (NAF), bootstrapping server function (BSF), and/or a home subscriber server (HSS) if the UE 302 is authenticated using GBA. In accordance with the illustrated embodiment, at 316, the MNO 308 performs authentication of the UE 302 using its stored subscriber credentials. At 318, the MNO 308 asserts the result of the authentication to the master IdP 306. At 320, the authentication result (assertion) is verified by the master IdP 106. The assertion is signed using the association secret (K_{myIdP}) from 311. At 322, the master IdP 306 sends the signed assertion to the SP 304. At 324, the SP 304 may send the UE 302 an indication that the UE 302 has been authenticated according to the authentication requirement, and thus the UE 302 may receive access to the requested service.

In another example embodiment, one-factor user authentication is implemented. User authentication may comprise providing proof of the presence of the user who is legitimately registered to use the service being sought. Such proof may be provided by login credentials such as, for example, a username and a password, a biometric (e.g., fingerprint), or the like, or any appropriate combination thereof. Along with proof of presence, an SP may insist on a certain required assurance level. Referring to FIG. 2, the assurance level may impact the type of passwords in use (e.g., strong versus weak passwords) and/or may warrant a biometric for example. The SP may require a certain freshness level of the authentication. For example, the SP may determine that an authentication is acceptable if the authentication took place less than 30 minutes ago, but the authentication is unacceptable if it took place greater than 30 minutes ago. The time of 30 minute is merely exemplary, and the freshness level may stipulate any appropriate time as desired. The master IdP may determine whether it can provide the required authentication itself, including the required assurance level and freshness level. The master IdP may decide to solicit the help of another IdP to help provide the authentication. In an alternative embodiment in which the user has an IMS subscription and no access to a mobile smartcard (e.g., UICC), SIP Digest may be used as described in TR 33.804: “Single Sign On (SSO) application security for Common IP Multimedia Subsystem (IMS) based Session Initiation Protocol (SIP) Digest”. For example, if the user is enters his/her SIP or IMS credentials then it can be referred to as a factor 1 authentication (e.g., what the user knows). If an IMS application within the UE stores the SIP credentials then it can be referred to as a factor 2 authentication (e.g., what the user has or possesses).

In another example embodiment, multi-factor authentication, for example two-factor authentication, is implemented. Multi-factor authentication may be required by service providers that provide services such as banking services and financial services for example. For example, an SP may want to be assured that the person using the device is the rightful registrant of the service. By virtue of an interworking agreement between the SP and a master IdP, for example, the master IdP may be directed to ensure that the authentication requirement is fulfilled. The master IdP may leverage the user's MNO subscription to authenticate the device. If the operator's infrastructure is GBA aware, GBA authentication may suffice. The master IdP may authenticate the user if it is capable of doing so. Alternatively, the master IdP may request assertions from another third party IdP.

Other service providers, such as services in the enterprise arena for example, may employ a form of user authentication in the form of hardware/software RSA token-based authentication. Such tokens can be presented using separate key fob devices or they can be generated in software on a mobile terminal, or on the mobile device's smart card for example. The use of the token information as an extension of the user's password adds a level of assurance to the authentication. Alternatively, the combination of a user authentication (e.g., using a user-entered password) and an application that runs within the device's universal subscriber identity module (USIM) may be implemented in such a way as to authenticate the user and the device. In an example embodiment, the MNO has corresponding processes running such that a challenge-response mechanism (e.g., network to UE and UE to network AKA or GBA) is setup in order to implement the two-factor authentication. A binding, which may be cryptographic for example, of the user authentication (e.g., using the user-entered password) and the token information generated on the UICC comprises the device response to the challenge. For example, the MNO may verify the device response if it has confirmed that the user was authenticated. By way of example, in the case of a password-based user authentication, a credential may be released upon successful local authentication of the user using the user-supplied password or information derived from the user-supplied password (e.g., a password digest). Further, a local user authentication may be implied by the credential (e.g., a key) being released. Thus, the release of the credential may confirm, from the MNO's perspective, that the user was locally authenticated. And the MNO may be in sync with a USIM application based authentication.

In an example two-factor authentication scenario, the master IdP, in its redirected assertion back to the SP for example, combines the assertions. For example, the master IdP may combine the assertion for the device and the assertion for the user to indicate that both authentications were successful. The combined assertion may comprise an indication that both authentications were successful as separate processes or successful as processes that were cryptographically bound together. The use of UICC based authentication as an extension to the user's password may add assurance to an authentication. Service providers may employ this form of authentication using the USIM application on the UICC.

In another example variant, the SP redirects authentication to a proxy master IdP, which reside locally on a UE, upon receiving the initial request for service message from the UE. The delegation of authentications and assertions to the target IdPs, with their return assertions to the master proxy IdP, may be performed as described herein. The master proxy IdP may redirect the combined/consolidated assertions to the SP via the UE in a secure manner. If the authentications succeeded, for example, the service is granted to the user.

Various examples described below illustrate example mechanisms that leverage an MNO controlled authentication infrastructure with MNO provisioned credentials that are stored on a mobile device. Although the examples illustrate mechanisms that use GBA, it will be understood that EAP (e.g., SIM, AKA, AKA′) and OpenID-EAP (e.g., with SIM, AKA, AKA′) embodiments that enable binding to MNO provisioned credentials can be implemented as desired.

Referring again to FIG. 3, the MNO authentication service may operate in compliance with the OpenID GBA protocol (e.g., see TR 33.924), or any other specified protocol for authentication by an MNO that may be combined with OpenID for example. A user IdP proxy may incorporate OpenID functionality (e.g., OpenID 2.0) and relying party (RP) functionality. Service provider and user IdP Proxy may function in compliance with OpenID 2.0. An Interworking arrangement between the IdPs may be established.

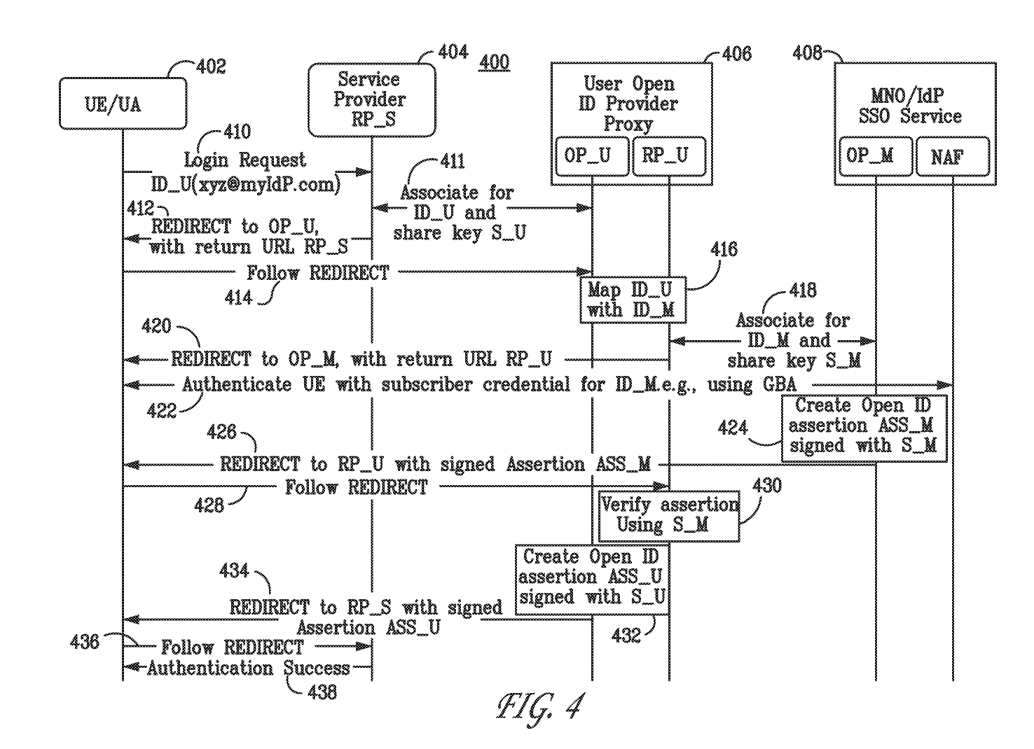

Referring to FIG. 4, a network 400 includes a UE 402, a SP 404, a user IdP (e.g., OpenID IdP) proxy 406, and an MNO 408, which can function as an IdP and thus may also be referred to as an IdP 408. In accordance with the illustrated embodiment, a user of the UE 402 subscribes to the MNO 408. At 410, the user wants to login to a service, and thus requests access to the service provided by the SP 404 using an original user identity (ID_U). At 411, an association key (S_U) is shared between the SP 404 and the user IdP proxy 406. At 412 and 414, the UE 402 is redirected to the user IdP proxy 406. In accordance with the illustrated embodiment, at 416, the original user identity ID_U that was provided at 410 (e.g., xyz@myIdP.com) is mapped to an identifier ID_M that is known by the MNO 408. For example, the identifier that is known by the MNO 408 may be a phone number, an international mobile subscriber identity (IMSI), or the like. The identifier ID_M may be required for association and provisioning between the user IdP 406 and the MNO 408, at 418.

In an alternative embodiment, the identifier ID_M that is known by the MNO 408 is appended to the original user identity ID_U and is provided to the SP at 410. In such an embodiment, the SP 404, and in particular the relying party (RP) function of the SP 404, recognizes the combination of identifiers. In another embodiment, mapping of the original user identity ID_U to the MNO known identity ID_M occurs in the association request at 411. For example, the SP 404 may look up a local database of mappings. Thus, each service provider may maintain corresponding mapping databases in accordance with an example embodiment. In accordance with yet another embodiment, the mapping may occur after receiving the association request at 411 at the SP 404. Alternatively, the UE 402 may map the user identifier ID_U to the identifier ID_M that is known by the MNO 408, for example before following the redirect at 414. At 420, the UE 402 is redirected to the MNO 408. The MNO 408 authenticates the UE 402 using its subscriber credentials, at 422. After performing the authentication, the MNO 408 creates and signs an authentication assertion, at 424. At 426 and 428, the UE 402 is redirected to the user IdP proxy 406. At 430, the user IdP proxy 406 verifies the authentication assertion. At 432, the user IdP proxy creates and signs a second authentication assertion, which is provided to the SP 404, via the UE 402 at 434 and 436. At 438, the SP 404 provides an authentication success message to the UE 402, thereby granting the UE 402 access to a service that is provided by the SP 404.

In various example embodiments described herein, the SP signals the specific requirement for authentication, such as by providing a required assurance level to an IdP or by explicitly identifying authentication factors that are required. The master IdP may select authentication factors if more than one combination of factors is capable, and permitted by the SP, of achieving the authentication requirement of the SP. Referring to FIG. 4, the SP 404 signals its authentication requirement to the MNO 408 via the UE 402. For example, such a signal may be interpreted and implemented by a local policy at the user IdP proxy 406. Alternatively, an explicit signal may be included in the protocol flow at 412 (e.g., a PAPE extension of an OpenID message). While the illustrated embodiment shown in FIG. 4 illustrates a one-factor authentication, it will be understood that the illustrated call flow can be extended for multi-factor authentication. For example, the UE and user 402 may be authenticated using two factors, wherein the MNO 408 authenticates the UE 402, and the user is authenticated by the user IdP proxy 406.

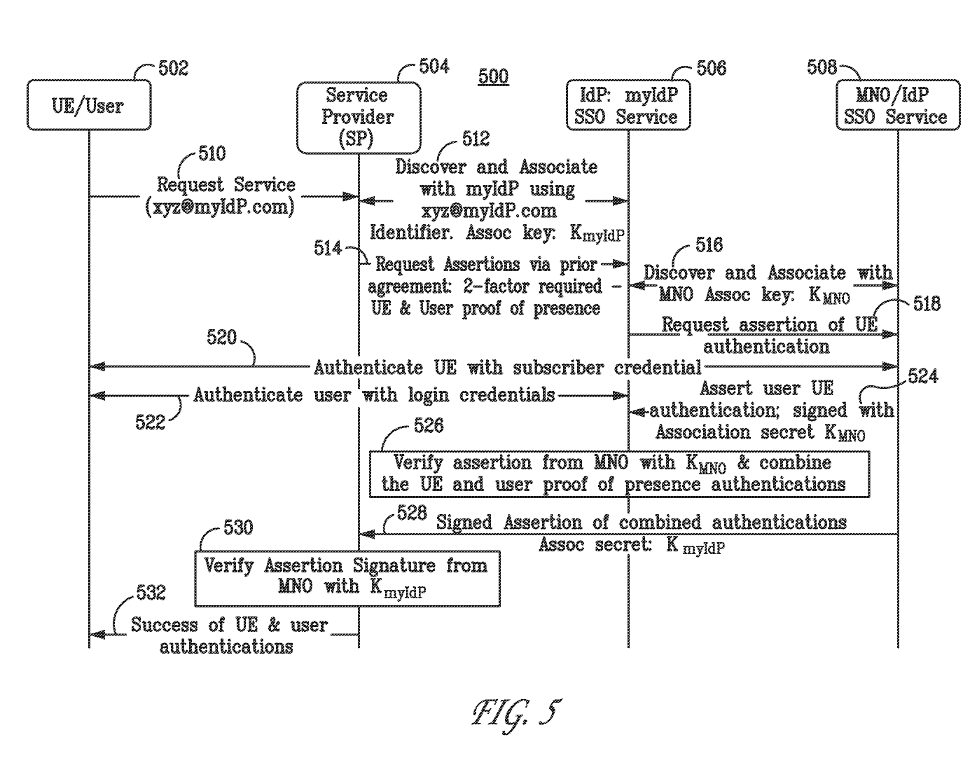

Referring to FIG. 5, in accordance with the illustrated embodiment, two-factor authentication is performed. A network 500 includes a UE 502, an SP 504, a master IdP 506, and an MNO 508. At 510, a user attempts to login to the SP 504, which provides an over-the-top application service (e.g., Facebook) or an enterprise network service requiring two-factor authentication. At 510, the user requests access to services from the SP 504 using a third party identity (e.g., a Facebook identity). The third party identity identifies the user and is associated with an IdP, for instance the IdP 506 (e.g., Facebook). The user may be re-directed to Facebook which may act as a master IdP for authentication. The third party identity provider (e.g., Facebook) may wish to perform strong authentication that requires two-factor authentication. Facebook, for example, may leverage GBA (or EAP-SIM) to perform boot-strapped authentication of the UE 502 separately from Facebook's authentication of the user.

Referring still to FIG. 5, in accordance with an example embodiment, at 512, the SP 504 and the master IdP 506 are associated with each other. At 514, the SP 504 requests a two factor authentication, in particular an authentication of the UE 502 and an authentication of the user of the UE 502. Upon verification of their first authentication factor by the over-the-top application service (e.g., the master IdP 506) at 522, the over-the-top application provider (e.g., the master IdP 506) initiates the second factor authentication (e.g., token-based) with the user's MNO 508 at 518. When the second factor authentication is completed, at 520, the result of the two authentications are bound together at 526. Such authentication binding may be achieved cryptographically or on a protocol level, for example. At 528, the MNO 508 sends a signed assertion of the combined authentications to the SP 504. At 530, the SP 504 verifies the signature of the signed assertion. At 532, the SP 504 provides an indication to the UE 502 that the UE 502 and the user of the UE 502 have been successfully authenticated.

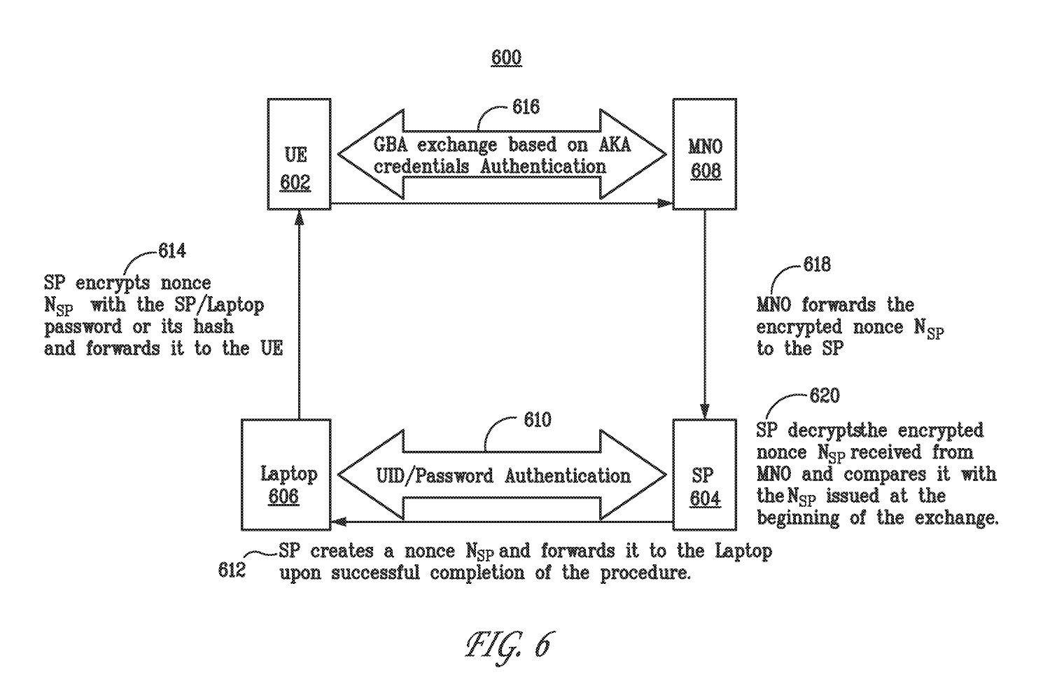

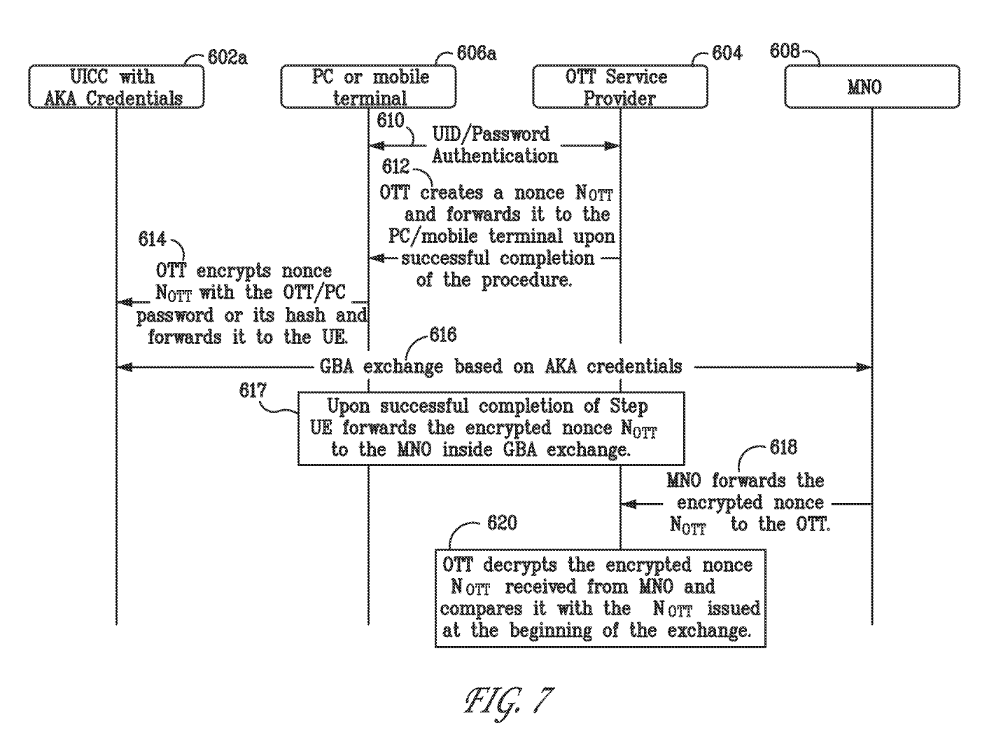

FIG. 6 is a block diagram that illustrates GBA for a secure two-factor authentication in accordance with an example embodiment. Referring to FIG. 6, a network 600 includes a UE 602, a SP 604, a laptop 606, and an MNO 408. Referring also to FIG. 7, at 610, a user identifier (UID) and/or user password is authenticated by the SP 604. Thus, the SP 604 establishes a first factor authentication. In accordance with the illustrated embodiment, the SP 604 decides, based on its policy for example, whether to proceed with a second authentication factor authentication. At 612, the SP 604 creates a nonce N_{SP} and forwards it to the laptop 606 upon successful completion of the authentication at 610. It will be understood that laptop 606 can be replaced by any appropriate computing device as desired, thus can also be referred to as a personal computer (PC) 606a or a mobile terminal 606a. In particular, functionality of the mobile terminal 606a can be performed by a browsing agent or mobile application on the mobile terminal 606a (see FIG. 7). At 614, the laptop 606 encrypts the nonce N_{SP} with the password and may create a digest (e.g., similar to a HTTP digest) shared by the SP 604 and the laptop 606, and forwards the password or its hash or digest to the UE 602, which can also be referred to as a UICC 602a (see FIG. 7). In an example embodiment, the interface between the UE 602 and the laptop 606 represents a split terminal configuration connecting the laptop 606 to the UE 602 (e.g., via Bluetooth or USB). In another example embodiment, the interface between the UE 602a and the laptop 606 represents a logical split between a browsing agent (e.g., browser or mobile application) and an authentication agent (e.g., UICC or IMS or SIP agent). In an alternative embodiment, the laptop 606 represents a collapsed version of the smart card/terminal interface on the UE 602. The split terminal interface can be protected via the key distribution service described in 3GPP TS 33.259: “Key Establishment between a UICC hosting device and a remote device” for example.

At 616, a GBA exchange based on AKA or based on IMS/SIP digest credentials occurs. Upon successful completion of the exchange at 616, the UE 602, at 617 (see FIG. 7) forwards the encrypted nonce N_{SP}. For example, the nonce N_{SP} can be forwarded to the MNO 608 using an information element (IE) inside a traditional GBA exchange. Alternatively, the GBA core protocol may be extended or modified to support such an IE. At 618, the MNO 608 forwards the encrypted nonce N_{SP} to the SP 604. At 620, the SP 604 decrypts the encrypted nonce N_{SP} received from the MNO 608 and compares it with the N_{SP} that was issued at the beginning of the exchange, thus completing an example of two-factor authentication using protocol binding according to an example embodiment.

In order to avoid security vulnerabilities, for example, protection and binding of the protocols may be achieved by sending parameters used in the authentication protocol along separate communications paths between the various entities involved in the authentication flow. For example, use of the nonce N_{SP} may ensure freshness of the proposed exchange and may mitigate replay attacks. Other mechanisms for splitting the protocol and/or parameters may be implemented. In accordance with the example embodiment shown in FIG. 7, steps 612, 614, 617, 618, and 620 create “proof of possession.” For example, the aforementioned steps may bind the first (e.g., UID/password) and the second (e.g., AKA credentials on the UICC) authentication factors, and thus ensure that the UE 602 and the computing device 606 are bound or are the same device, and thus the steps may prevent a “split identity” attack. The encrypted nonce N_{SP} may be used instead of the same nonce in cleartext to prevent man-in-the-middle attacks in the above exchange. In addition, the use of confidentiality-protection may relax confidentiality requirements on the GBA exchange in step 616.

In an alternative example embodiment, the laptop 606 and the UE 602 configuration illustrated in FIG. 6 is collapsed into a single entity such as a mobile phone. In yet another embodiment, as shown in FIG. 7, the UE 602 is implemented by the UICC 602a, and functionality of the laptop 606 is implemented by a mobile phone or a laptop with cellular capability, and thus the laptop 606 may also be referred to as the mobile terminal 606a, or more particularly a browsing agent or mobile application (see FIG. 7). The mobile terminal 606a may be connected to the UICC 602a via a local communications link.

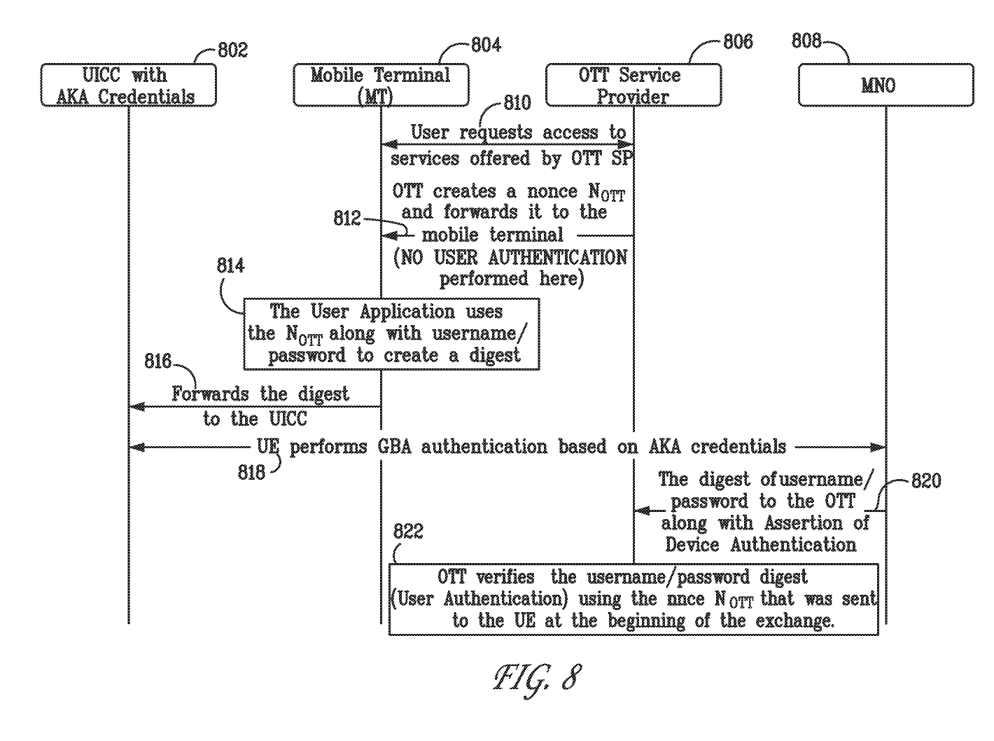

Referring to FIG. 8, an example variation of the flow in FIG. 7 is illustrated, in which the user authentication is performed at a later stage and combined with the device authentication process. Tight binding can be achieved between the user authentication and device authentication (e.g., protocol binding) by sending a hashed username/password or a digest as part of the device authentication, instead of only sending a Nonce for example.

Referring to FIG. 8, in accordance with the illustrated embodiment, at 810, a user requests access to a service that is provided by an OTT service provider (SP) 806. At 812, the OTT SP 806 generates a nonce N_{OTT}, and requests a UE 804, which can also be referred to as a mobile terminal 804, to perform a user authentication using the nonce N_{OTT}. The OTT SP 806 may instruct the UE 804 to perform a device authentication based on GBA for example. At 814, the user application on the UE 804 uses the password and/or the username along with the N_{OTT} to create a digest. At 816, the mobile terminal (MT) 804 forwards the digest to a UICC 802. In a split terminal configuration in which a browsing agent and the authentication agent are residing on different physical entities, the split terminal may implement the steps of the MT 804 illustrated in FIG. 8. The MT 804 also instructs the UICC 802 to start the GBA process, for example, if GBA is used as the authentication process for performing device authentication. At 818, the UICC 802 and the BSF/NAF (e.g., the MNO 808) perform the GBA Bootstrapping protocol. As part of the protocol, the UICC 802 sends the digest that was derived as part of the user authentication. The digest may be sent by the UICC 802 as an additional message or it may be incorporated into the bootstrapping messaging. At 820, if the UE 804 has been successfully authenticated for example, the BSF/NAF sends a positive assertion that indicates that the UE 804 has been authenticated. Alternatively, if the authentication has failed for example, the BSF/NAF sends a negative assertion. With the assertion, which may be positive or negative, the BSF/NAF sends the digest that was sent to it by the UICC 802 as part of the user authentication. At 822, the OTT SP 806 verifies the digest that is received, and if the digest is the expected digest for example, then the user may be provided with limited access or full access. The level of access (e.g., limited or full) may be determined by a policy of the SP 806. For example, in accordance with an example embodiment, the user is provided with limited access to the service that is provided by the OTT SP 806 if the expected digest is received and a negative device assertion is received, and the user is provided with full access to the service that is provided by the OTT SP 806 if a positive device assertion is received and the expected digest is also received. In accordance with the example embodiment, receiving the expected digest indicates that the user was successfully authenticated, and receiving a negative device assertion indicates that the device was not successfully authenticated.

By way of example, in an alternative variant to the embodiment shown in FIG. 8, the user presents the digest of its password that was computed using the N_{OTT} and the password itself to the OTT SP. The user may also present the username to the OTT SP. The UICC sends the digest via the GBA process (step 818 in FIG. 8) through the MNO to the OTT (see 820 in FIG. 8). The OTT SP then compares the digest that was received from the user to the one received from the MNO, and if the digests match the user is authenticated.

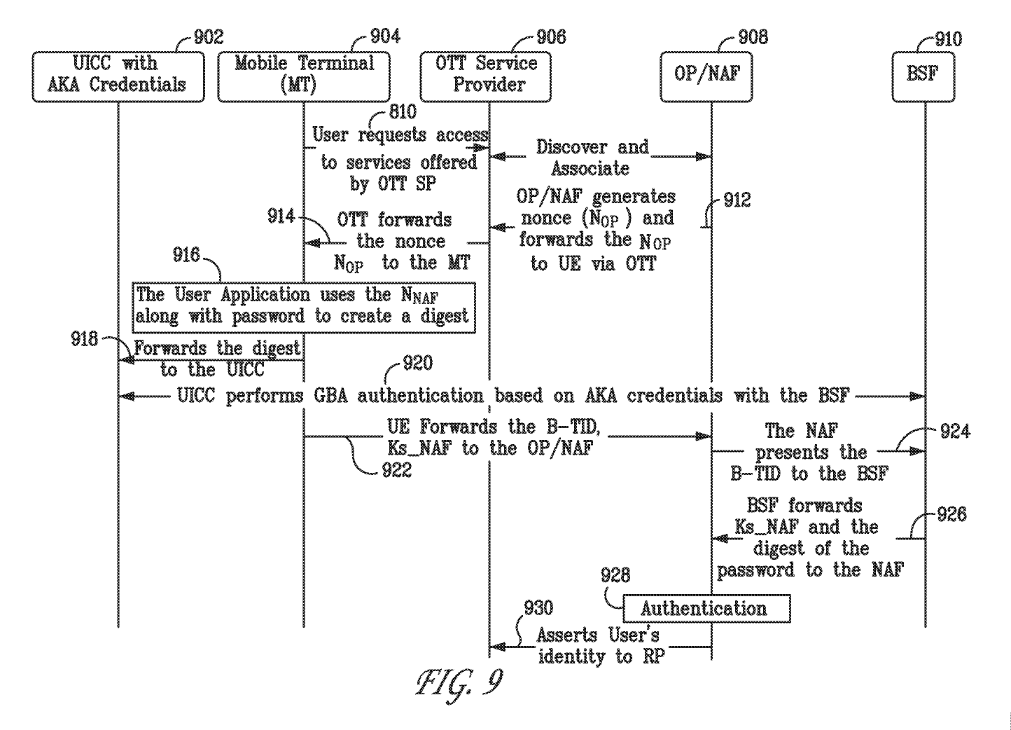

FIG. 9 illustrates an example embodiment in which an OP/NAF 908 generates a Nonce (N_{OP}) and performs the authentication, and asserts the identities to a OTT SP 906. The example call flow illustrated in FIG. 9 is based on an OpenID/GBA integration call flow. The example call flow illustrated in FIG. 9 enables multi-factor authentication, binds the authentications, and the allows the OP/NAF 908 to assert both the user's identity and the device's identity to the OTT SP 906.

Referring to FIG. 9, at 912, the OP/NAF 908 generates the Nonce N_{OP}. The OP/NAF 908 may forward the N_{OP} to a UE 904 via the OTT SP 906 (at 914) or it may be directly sent to the UE 904. This differs from other embodiments in which the OTT SP 906 generates the Nonce. At 916, the user application on the UE 904 uses the password and/or the username along with the N_{NOP} to create a digest. At 918, the mobile terminal (MT) 904 forwards the digest to a UICC 902. In a split terminal configuration in which a browsing agent and the authentication agent are residing on different physical entities, the split terminal may implement the steps of the MT 904 illustrated in FIG. 9. The MT 904 also instructs the UICC 902 to start the GBA process, for example, if GBA is used as the authentication process for performing device authentication. At 920, the UICC 902 and a BSF 910 perform the GBA Bootstrapping protocol. As part of the protocol, the UICC 902 sends the digest that was derived as part of the user authentication. The digest may be sent by the UICC 902 as an additional message or it may be incorporated into the bootstrapping messaging. At 922, the UE 904 forwards the B-TID and a Ks_NAF to the OP/NAF 908. At 924, the OP/NAF 908 sends the B-TID to the BSF 910. At 926, the BSF 910 forwards the Ks_NAF and the digest of the password to the OP/NAF 908. The OP/NAF 908 computes the digest of the user's password and compares it to the digest received from the UE 904, which was sent via the BSF 910. If the digests are the same and the Ks_NAF is the same, for example, the OP/NAF 908 authenticates the UE 904 and the user of the UE 904, at 928. At 930, the OP/NAF 908 asserts the respective identities of the UE 902 and its user to the OTT SP 908.

In yet another example embodiment, the Ks_NAF and the digest of the user's password are cryptographically bound or combined. Such a binding may be implemented by a function KDF (N_{OP}, Ks_NAF, digest of password) or KDF (Ks_NAF, digest of password) that generates a key. The key can be used to generate other keys for securing communications or as a password for accessing services.

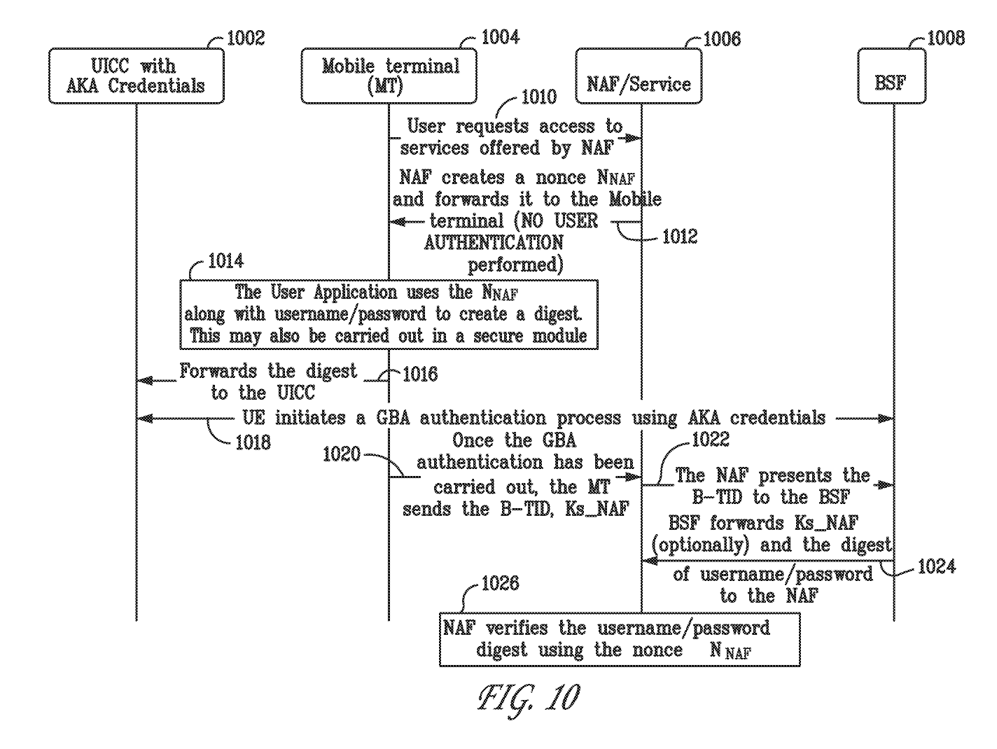

FIG. 10 illustrates one example embodiment of multi-factor authentication using GBA in which an MNO 1006 is the IdP, and a third-party IdP is not involved. As shown in the illustrated embodiment, the service hosted by the MNO 1006 requires multi-factor authentication and the service binds the factors of authentication. Because GBA is implemented, the MNO 1006 can be referred to as the NAF 1006.

Referring to FIG. 10, in accordance with the illustrated embodiment, at 1010, a mobile terminal (MT) 1004 requests access to services that are offered by the network access function (NAF) 1006. At 1012, the NAF 1006 creates a nonce (N_{NAF}) and forwards it to the MT 1004 so that user authentication can be performed. The NAF 1006 may request that the MT 1004 perform a multi-factor authentication or it may be policy driven within the device 1004, for example. For example, the notification to request multi-factor authentication by the NAF 1006 may be implemented by modifying HTTP header values to include the required authentication factors. At 1014, the user application /GBA application or the GBA API on the MT/UE 1004 uses the N_{NAF} and creates a digest of the user's password. In an example embodiment, a username may also be used in conjunction with the password to create the digest. The digest may be generated within secure hardware. At 1016, the application forwards the digest to a UICC 1002 and invokes the UICC 1002 to perform a GBA authentication process. At 1018, the UICC 1002 and a BSF 1008 perform the GBA bootstrapping procedure. As part of the GBA, for example, the UE 1004 may send the digest (of the user's password) that was created using N_{NAF}. At 1020, once the GBA process is completed, for example, the MT 1004 sends the Bootstrap ID (B-TID) to the NAF 1006. The MT 1004 may send a Ks_NAF with the B-TID. At 1022, the NAF 1006 presents the B-TID to the BSF 1008, for example, to obtain the UE's credentials and the user's credentials. At 1024, the BSF 1008 forwards the Ks_NAF and the digest of the password that was sent by the UICC 1002 as part of the GBA process. At 1026, the NAF 1006 verifies the digest of the UE's password using the N_{NAF} that was sent by the NAF 1006 to the UE 1004. The NAF 1006 also verifies the Ks_NAF obtained from the BSF 1008 and compares it with the Ks_NAF that was sent by the UE 1004. Such a comparison may verify the authentication of the subscription. The NAF 1006 may bind the authentications cryptographically or at a protocol level.

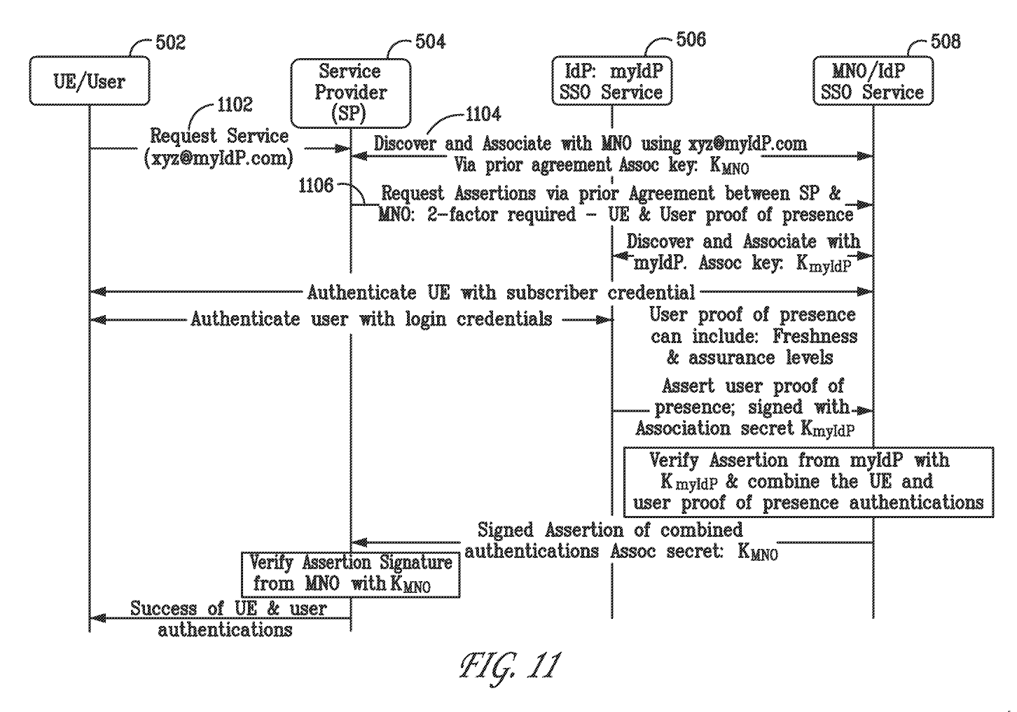

FIG. 11 is a call flow of an example embodiment that implements two-factor authentication with MNO control (MNO as the master IdP), instead of third party control as shown in FIG. 5. In such an embodiment, when the MNO IdP 508 is a master, a user identity for a third party IdP may be redirected, from the SP 504, to an MNO provisioned IdP service. For example, at 1102, the identifier (xyz@myIdP.com) is initially associated with the third party IdP 506 (myIdP) when it is sent by the user to the SP 504. By virtue of a prior agreement (see 1104) with the MNO 508 or user, for example, the SP 504 redirects its “request for assertion” message at 1106 to the MNO 508, which recognizes the identifier, instead of redirecting it to myIdP 506. According to policies or in response to an implicit or explicit request from the SP 504, the MNO 508 may perform two-factor authentication. One factor may authenticate the user and one factor may authenticate the UE 502. The MNO 508 may function as the controller and may direct myIdP 506 to authenticate the user. The UE 502 may be separately authenticated by the MNO 508.

In an alternate example configuration, it is understood from the initial request for service message by the user to the SP that the user is an MNO subscriber and possesses a third party identity registered with myIdP. The initial message may comprise information other than the identifier for myIdP which allows discovery of the MNO. Such information may be explicit, implicit, in the form of a decorated identifier, or a combination thereof.

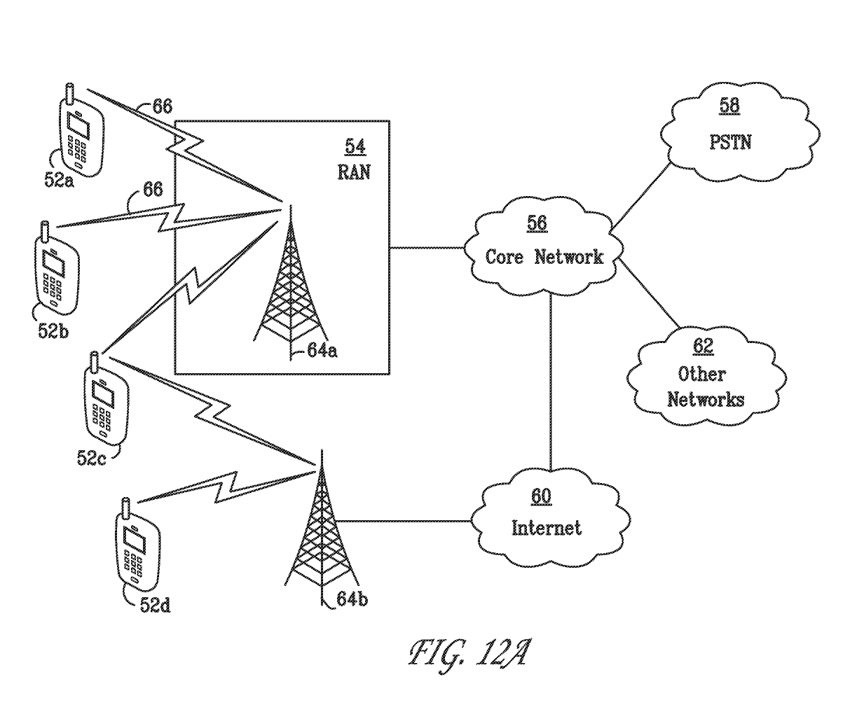

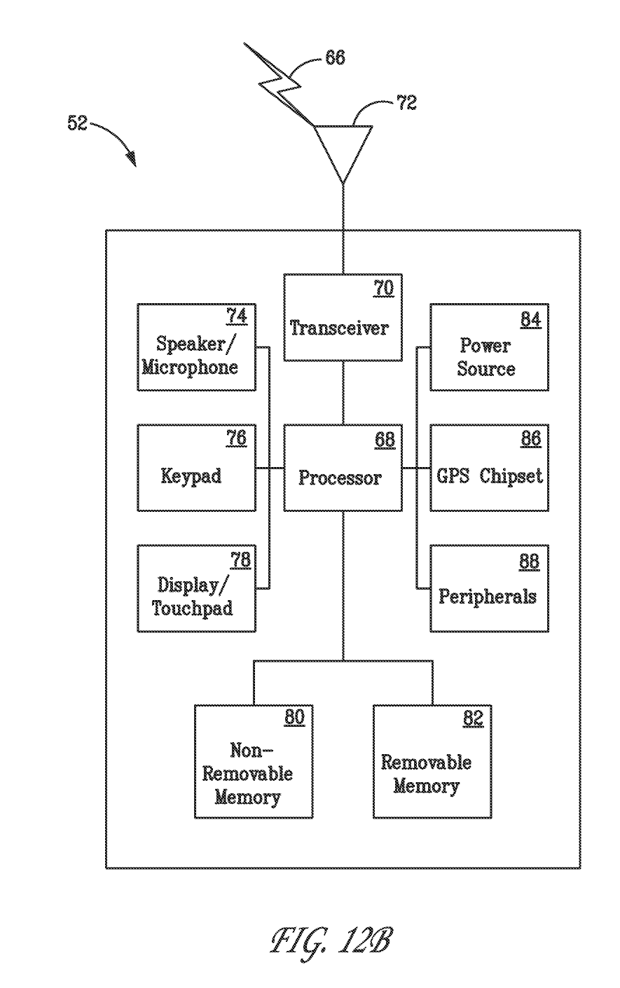

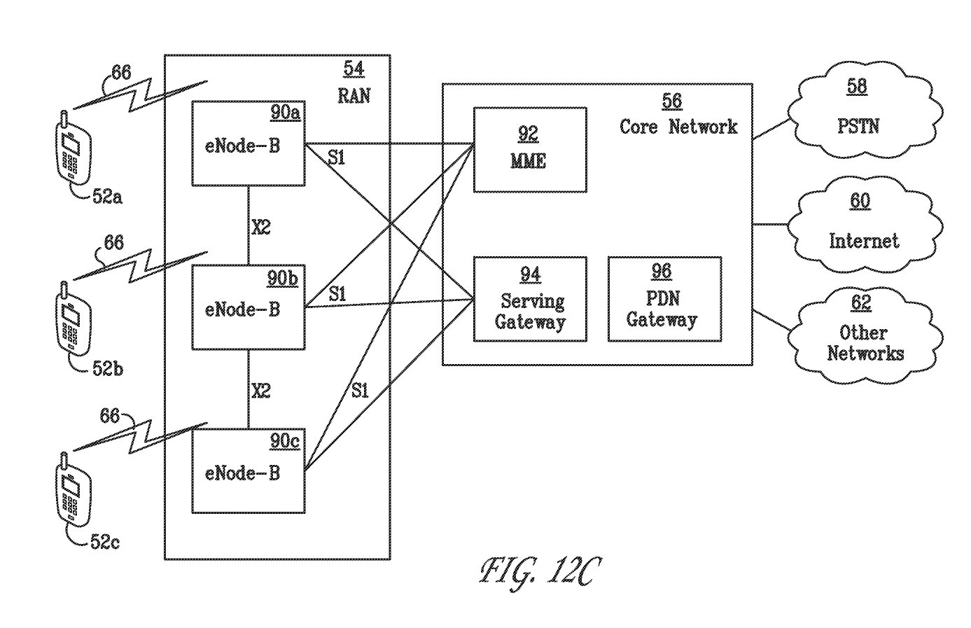

FIG. 12A is a diagram of an example communications system 50 in which one or more disclosed embodiments may be implemented. The communications system 50 may be a multiple access system that provides content, such as voice, data, video, messaging, broadcast, etc., to multiple wireless users. The communications system 50 may enable multiple wireless users to access such content through the sharing of system resources, including wireless bandwidth. For example, the communications systems 50 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 12A, the communications system 50 may include wireless transmit/receive units (WTRUs) 52a, 52b, 52c, 52d, a radio access network (RAN) 54, a core network 56, a public switched telephone network (PSTN) 808, the Internet 810, and other networks 812, though it will be appreciated that the disclosed embodiments contemplate any number of WTRUs, base stations, networks, and/or network elements. Each of the WTRUs 52a, 52b, 52c, 52d may be any type of device configured to operate and/or communicate in a wireless environment. By way of example, the WTRUs 52a, 52b, 52c, 52d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 50 may also include a base station 64a and a base station 64b. Each of the base stations 64a, 64b may be any type of device configured to wirelessly interface with at least one of the WTRUs 52a, 52b, 52c, 52d to facilitate access to one or more communication networks, such as the core network 56, the Internet 60, and/or the networks 62. By way of example, the base stations 64a, 64b may be a base transceiver station (BTS), a Node-B, an eNode B, a Home Node B, a Home eNode B, a site controller, an access point (AP), a wireless router, and the like. While the base stations 64a, 64b are each depicted as a single element, it will be appreciated that the base stations 64a, 64b may include any number of interconnected base stations and/or network elements.

The base station 64a may be part of the RAN 54, which may also include other base stations and/or network elements (not shown), such as a base station controller (BSC), a radio network controller (RNC), relay nodes, etc. The base station 64a and/or the base station 64b may be configured to transmit and/or receive wireless signals within a particular geographic region, which may be referred to as a cell (not shown). The cell may further be divided into cell sectors. For example, the cell associated with the base station 64a may be divided into three sectors. Thus, in an embodiment, the base station 64a may include three transceivers, i.e., one for each sector of the cell. In an embodiment, the base station 64a may employ multiple-input multiple output (MIMO) technology and, therefore, may utilize multiple transceivers for each sector of the cell.

The base stations 64a, 64b may communicate with one or more of the WTRUs 52a, 52b, 52c, 52d over an air interface 66, which may be any suitable wireless communication link (e.g., radio frequency (RF), microwave, infrared (IR), ultraviolet (UV), visible light, etc.). The air interface 66 may be established using any suitable radio access technology (RAT).

More specifically, as noted above, the communications system 50 may be a multiple access system and may employ one or more channel access schemes, such as CDMA, TDMA, FDMA, OFDMA, SC-FDMA, and the like. For example, the base station 64a in the RAN 54 and the WTRUs 52a, 52b, 52c may implement a radio technology such as Universal Mobile Telecommunications System (UMTS) Terrestrial Radio Access (UTRA), which may establish the air interface 816 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 64a and the WTRUs 52a, 52b, 52c may implement a radio technology such as Evolved UMTS Terrestrial Radio Access (E-UTRA), which may establish the air interface 66 using Long Term Evolution (LTE) and/or LTE-Advanced (LTE-A).

In other embodiments, the base station 64a and the WTRUs 52a, 52b, 52c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 64b in FIG. 12A may be a wireless router, Home Node B, Home eNode B, femto cell base station, or access point, for example, and may utilize any suitable RAT for facilitating wireless connectivity in a localized area, such as a place of business, a home, a vehicle, a campus, and the like. In an embodiment, the base station 64b and the WTRUs 52c, 52d may implement a radio technology such as IEEE 802.11 to establish a wireless local area network (WLAN). In an embodiment, the base station 814b and the WTRUs 52c, 52d may implement a radio technology such as IEEE 802.15 to establish a wireless personal area network (WPAN). In yet an embodiment, the base station 64b and the WTRUs 52c, 52d may utilize a cellular-based RAT (e.g., WCDMA, CDMA2000, GSM, LTE, LTE-A, etc.) to establish a picocell or femtocell. As shown in FIG. 12A, the base station 64b may have a direct connection to the Internet 60. Thus, the base station 64b may not be required to access the Internet 60 via the core network 56.

The RAN 54 may be in communication with the core network 56, which may be any type of network configured to provide voice, data, applications, and/or voice over internet protocol (VoIP) services to one or more of the WTRUs 52a, 52b, 52c, 52d. For example, the core network 56 may provide call control, billing services, mobile location-based services, pre-paid calling, Internet connectivity, video distribution, etc., and/or perform high-level security functions, such as user authentication. Although not shown in FIG. 12A, it will be appreciated that the RAN 54 and/or the core network 56 may be in direct or indirect communication with other RANs that employ the same RAT as the RAN 54 or a different RAT. For example, in addition to being connected to the RAN 54, which may be utilizing an E-UTRA radio technology, the core network 56 may also be in communication with another RAN (not shown) employing a GSM radio technology.

The core network 56 may also serve as a gateway for the WTRUs 52a, 52b, 52c, 52d to access the PSTN 58, the Internet 60, and/or other networks 62. The PSTN 58 may include circuit-switched telephone networks that provide plain old telephone service (POTS). The Internet 60 may include a global system of interconnected computer networks and devices that use common communication protocols, such as the transmission control protocol (TCP), user datagram protocol (UDP) and the internet protocol (IP) in the TCP/IP internet protocol suite. The networks 62 may include wired or wireless communications networks owned and/or operated by other service providers. For example, the networks 62 may include another core network connected to one or more RANs, which may employ the same RAT as the RAN 54 or a different RAT.

Some or all of the WTRUs 52a, 52b, 52c, 52d in the communications system 800 may include multi-mode capabilities, i.e., the WTRUs 52a, 52b, 52c, 52d may include multiple transceivers for communicating with different wireless networks over different wireless links. For example, the WTRU 52c shown in FIG. 12A may be configured to communicate with the base station 64a, which may employ a cellular-based radio technology, and with the base station 64b, which may employ an IEEE 802 radio technology.

FIG. 12B is a system diagram of an example WTRU 52. As shown in FIG. 12B, the WTRU 52 may include a processor 68, a transceiver 70, a transmit/receive element 72, a speaker/microphone 74, a keypad 76, a display/touchpad 78, non-removable memory 80, removable memory 82, a power source 84, a global positioning system (GPS) chipset 86, and other peripherals 88. It will be appreciated that the WTRU 52 may include any sub-combination of the foregoing elements while remaining consistent with an embodiment.

The processor 68 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 818 may perform signal coding, data processing, power control, input/output processing, and/or any other functionality that enables the WTRU 52 to operate in a wireless environment. The processor 68 may be coupled to the transceiver 70, which may be coupled to the transmit/receive element 72. While FIG. 12B depicts the processor 68 and the transceiver 70 as separate components, it will be appreciated that the processor 68 and the transceiver 70 may be integrated together in an electronic package or chip. The processor 68 may perform application-layer programs (e.g., browsers) and/or radio access-layer (RAN) programs and/or communications. The processor 68 may perform security operations such as authentication, security key agreement, and/or cryptographic operations, such as at the access-layer and/or application layer for example.

The transmit/receive element 72 may be configured to transmit signals to, or receive signals from, a base station (e.g., the base station 64a) over the air interface 66. For example, in an embodiment, the transmit/receive element 72 may be an antenna configured to transmit and/or receive RF signals. In an embodiment, the transmit/receive element 72 may be an emitter/detector configured to transmit and/or receive IR, UV, or visible light signals, for example. In yet an embodiment, the transmit/receive element 72 may be configured to transmit and receive both RF and light signals. It will be appreciated that the transmit/receive element 72 may be configured to transmit and/or receive any combination of wireless signals.

In addition, although the transmit/receive element 72 is depicted in FIG. 12B as a single element, the WTRU 52 may include any number of transmit/receive elements 72. More specifically, the WTRU 52 may employ MIMO technology. Thus, in an embodiment, the WTRU 52 may include two or more transmit/receive elements 72 (e.g., multiple antennas) for transmitting and receiving wireless signals over the air interface 66.

The transceiver 70 may be configured to modulate the signals that are to be transmitted by the transmit/receive element 72 and to demodulate the signals that are received by the transmit/receive element 72. As noted above, the WTRU 52 may have multi-mode capabilities. Thus, the transceiver 70 may include multiple transceivers for enabling the WTRU 52 to communicate via multiple RATs, such as UTRA and IEEE 802.11, for example.

The processor 68 of the WTRU 52 may be coupled to, and may receive user input data from, the speaker/microphone 74, the keypad 76, and/or the display/touchpad 78 (e.g., a liquid crystal display (LCD) display unit or organic light-emitting diode (OLED) display unit). The processor 68 may also output user data to the speaker/microphone 74, the keypad 76, and/or the display/touchpad 78. In addition, the processor 818 may access information from, and store data in, any type of suitable memory, such as the non-removable memory 80 and/or the removable memory 82. The non-removable memory 80 may include random-access memory (RAM), read-only memory (ROM), a hard disk, or any other type of memory storage device. The removable memory 82 may include a subscriber identity module (SIM) card, a memory stick, a secure digital (SD) memory card, and the like. In other embodiments, the processor 818 may access information from, and store data in, memory that is not physically located on the WTRU 52, such as on a server or a home computer (not shown).

The processor 68 may receive power from the power source 84, and may be configured to distribute and/or control the power to the other components in the WTRU 52. The power source 84 may be any suitable device for powering the WTRU 52. For example, the power source 84 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 68 may also be coupled to the GPS chipset 86, which may be configured to provide location information (e.g., longitude and latitude) regarding the current location of the WTRU 52. In addition to, or in lieu of, the information from the GPS chipset 86, the WTRU 52 may receive location information over the air interface 816 from a base station (e.g., base stations 64a, 64b) and/or determine its location based on the timing of the signals being received from two or more nearby base stations. It will be appreciated that the WTRU 52 may acquire location information by way of any suitable location-determination method while remaining consistent with an embodiment.

The processor 68 may further be coupled to other peripherals 88, which may include one or more software and/or hardware modules that provide additional features, functionality and/or wired or wireless connectivity. For example, the peripherals 88 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 12C is a system diagram of the RAN 54 and the core network 806 according to an embodiment. As noted above, the RAN 54 may employ a UTRA radio technology to communicate with the WTRUs 52a, 52b, 52c over the air interface 66. The RAN 54 may also be in communication with the core network 806. As shown in FIG. 12C, the RAN 54 may include Node-Bs 90a, 90b, 90c, which may each include one or more transceivers for communicating with the WTRUs 52a, 52b, 52c over the air interface 66. The Node-Bs 90a, 90b, 90c may each be associated with a particular cell (not shown) within the RAN 54. The RAN 54 may also include RNCs 92a, 92b. It will be appreciated that the RAN 54 may include any number of Node-Bs and RNCs while remaining consistent with an embodiment.

As shown in FIG. 12C, the Node-Bs 90a, 90b may be in communication with the RNC 92a. Additionally, the Node-B 90c may be in communication with the RNC 92b. The Node-Bs 90a, 90b, 90c may communicate with the respective RNCs 92a, 92b via an Iub interface. The RNCs 92a, 92b may be in communication with one another via an Iur interface. Each of the RNCs 92a, 92b may be configured to control the respective Node-Bs 90a, 90b, 90c to which it is connected. In addition, each of the RNCs 92a, 92b may be configured to carry out and/or support other functionality, such as outer loop power control, load control, admission control, packet scheduling, handover control, macrodiversity, security functions, data encryption, and the like.

The core network 806 shown in FIG. 12C may include a media gateway (MGW) 844, a mobile switching center (MSC) 96, a serving GPRS support node (SGSN) 98, and/or a gateway GPRS support node (GGSN) 99. While each of the foregoing elements are depicted as part of the core network 56, it will be appreciated that any one of these elements may be owned and/or operated by an entity other than the core network operator.

The RNC 92a in the RAN 54 may be connected to the MSC 96 in the core network 56 via an IuCS interface. The MSC 96 may be connected to the MGW 94. The MSC 96 and the MGW 94 may provide the WTRUs 52a, 52b, 52c with access to circuit-switched networks, such as the PSTN 58, to facilitate communications between the WTRUs 52a, 52b, 52c and traditional land-line communications devices.

The RNC 92a in the RAN 54 may also be connected to the SGSN 98 in the core network 806 via an IuPS interface. The SGSN 98 may be connected to the GGSN 99. The SGSN 98 and the GGSN 99 may provide the WTRUs 52a, 52b, 52c with access to packet-switched networks, such as the Internet 60, to facilitate communications between and the WTRUs 52a, 52b, 52c and IP-enabled devices.

As noted above, the core network 56 may also be connected to the networks 62, which may include other wired or wireless networks that are owned and/or operated by other service providers.

Although features and elements are described above in particular combinations, each feature or element can be used alone or in any combination with the other features and elements. Additionally, the embodiments described herein are provided for exemplary purposes only. For example, while embodiments may be described herein using OpenID and/or SSO authentication entities and functions, similar embodiments may be implemented using other authentication entities and functions. Furthermore, the embodiments described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for performing multi-factor authentication, comprising:
receiving, at a master identity provider (M-IdP), a request from a service provider to authenticate a user who has requested access to a service via a user equipment (UE), the request including an indication of an authentication requirement and an identity of the user that is associated with the M-IdP;
determining a plurality of authentication factors capable of achieving the authentication requirement;
based on the user identity associated with the M-IdP, determining an identity of the user or the UE associated with select ones of the determined authentication factors;
using the identities associated with the select ones of the authentication factors, requesting an authentication for each select factor;
receiving a result of the authentication for each select factor and combining the results to create an authentication assertion that indicates successful authentication in accordance with the authentication requirement; and
sending the authentication assertion to the service provider.

2. The method as recited in claim 1, wherein the indication of the authentication requirement comprises a required authentication assurance level.

3. The method as recited in claim 1, wherein the indication of the authentication requirement comprises an identification of required authentication factors.

4. The method as recited in claim 1, the method further comprising encrypting the authentication assertion.

5. The method as recited in claim 1, wherein the results that are received for each select authentication factor are encrypted.

6. The method as recited in claim 1, wherein one of the plurality of select authentication factors include credentials of the UE that are authenticated by a mobile network operator to which the user subscribes.

7. The method as recited in claim 1, wherein the M-IdP is a mobile network operator to which the user subscribes.

8. The method as recited in claim 1, wherein each result of the authentication for each select factor is received from a different identity provider.

9. The method as recited in claim 8, wherein the different identity providers are determined in accordance with a policy of the service provider.

10. The method as recited in claim 1, wherein the step of combining the results further comprises cryptographically binding the results together.

11. The method as recited in claim 1, wherein the result for each select authentication factor comprises a corresponding assurance level and a corresponding freshness level.

12. The method as recited in claim 1, wherein the service provider is the M-IdP.

13. The method as recited in claim 1, wherein at least one authentication for at least one select fact is performed at the M-IdP.

14. A method for performing multi-factor authentication, comprising:
receiving, at a master identity provider (M-IdP), a request from a service provider to authenticate a user who has requested access to a service via a user equipment (UE), the request including an indication of an authentication requirement and an identity of the user associated with the M-IdP;
determining a plurality of authentication factors capable of achieving the authentication requirement;
performing an authentication for select factors;
obtaining a result of the authentication for the select factors and combining the results to create an authentication assertion that indicates successful authentication in accordance with the authentication requirement; and
sending the authentication assertion to the service provider.

15. The method as recited in claim 14, the method further comprising:
binding the plurality of authentication factors together with each other.

16. The method as recited in claim 14, the method further comprising:
selecting ones of the determined plurality of authentication factors capable of achieving the required authentication assurance level.

17. The method as recited in claim 16, wherein the selecting step is based on an indication received from the UE.

18. An apparatus comprising:
a memory comprising executable instructions; and
a processor in communications with the memory, the instructions, when executed by the processor, cause the processor to effectuate operations comprising:
receiving, at a master identity provider (M-IdP), a request from a service provider to authenticate a user who has requested access to a service via a user equipment (UE), the request including an indication of an authentication requirement and an identity of the user that is associated with the M-IdP;
determining a plurality of authentication factors capable of achieving the authentication requirement;
based on the user identity associated with the M-IdP, determining an identity of the user or the UE associated with select ones of the determined authentication factors;
using the identities associated with the select ones of the authentication factors, requesting an authentication for each select factor;
receiving a result of the authentication for each select factor and combining the results to create an authentication assertion that indicates successful authentication in accordance with the authentication requirement; and
sending the authentication assertion to the service provider.

19. The apparatus as recited in claim 18, wherein one of the plurality of select authentication factors include credentials of the UE that are authenticated by a mobile network operator to which the user subscribes.

20. The apparatus as recited in claim 18, wherein each result of the authentication for each select factor is received from a different identity provider.
